(19) United States
(12) Patent Application Publication
(10) Pub. No.: US 2007/0003673 A1
(43) Pub. Date: Jan. 4, 2007

(54) Process for producing soybean protein-containing wheat dough

(76) Inventor: Isao Ochi, Tsukuba-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/581,205

(22) PCT Filed: Oct. 26, 2004
(86) PCT No.: PCT/JP04/15844

§ 371 Date: Jun. 1, 2006

(30) Foreign Application Priority Data
Dec. 25, 2003 (JP) 2003-430198

(51) Int. Cl. A21D 13/00

(52) U.S. Cl. 426/94; 426/656

(57) ABSTRACT

It is intended to provide a process for producing a soybean protein-containing wheat dough, i.e., a dough with the use of soybean protein which is scarcely affected by the strong moisture absorptivity of soybean, shows little change in dough hardness with the passage of time and has excellent workability. Namely, a process for producing wheat dough characterized by comprising adding soybean protein as a plastic mixture with a sugar having been preliminarily prepared. In the case where the plastic mixture comprises soybean protein with liquid sugar, the content of soybean protein in the plastic mixture is from 12 to 38% by weight in terms of solid soybean protein and the moisture activity of the liquid sugar to be employed in the plastic mixture is 0.95 or less. A process for producing a wheat product characterized by comprising heating the above wheat dough is also provided.

### TECHNICAL FIELD

The present invention relates to a process for producing soybean protein-containing wheat dough in which soybean protein is added as a plastic mixture with a sugar in the form of liquid, and a process for producing a wheat product by heating the dough.

### BACKGROUND ART

An effect of soybean foods, soymilks and the like on health has been noted in recent years, and there is increasing demand for wheat products such as baked confectionery, bread and the like using soybean protein in view of good health. Since cookies which are one of baked confectionery are handy confectionery, and can be conveniently eaten in various places, attempts have been made to use soybean protein in cookies. Dough of cookies has plasticity, and is molded into various shapes by, for example, squeezing or encrusting machine-molding, and baked.

It is important that plasticity of dough is stable at a stage of confectionery production and, for example, when plasticity of dough greatly varies with time, the production becomes unstable, thereby adversely influencing on the production. When soybean protein is used in dough of a cookie, in a generally employed method, soybean protein is preliminarily mixed with wheat flour and then the mixture is kneaded into dough at a final stage of dough production. In addition, a flour batter method is employed so as to delay a chance to contact an aqueous component such as an egg in dough with soybean protein. In the flour batter method, fat or oil such as margarine, shortening or the like is preliminarily mixed with soybean protein, followed by mixing with a sugar, an egg and wheat flour. However, in all of these methods, dough using soybean protein undergoes influence of strong water absorption properties of soybean protein, and hardness of the dough is increased with time, thereby deteriorating workability. Since it is difficult to reduce this change in plasticity of the dough, the amount of soybean protein to be used should be restricted, and there has been a demand to avoid this.

As utilization of soybean protein in baked confectionery, Patent Document 1 proposes a process for producing baked confectionery comprising baking wheat dough containing soybean protein and a coagulating agent. This process is directed to improvement of a flavor using an alkaline earth metal as the coagulating agent. Patent Document 2 proposes a process which improves baking shrinkage and volume reduction upon baking by using enzymatic degradation soybean protein in a butter cake having low specific gravity. Patent Document 3 proposes baked confectionery comprising wheat flour, a soybean protein constituent raw material, and vegetable fat or oil as main raw materials. The baked confectionery contains the soybean protein constituent raw material in an amount of about 10 to about 65 parts by weight, and the vegetable fat or oil in an amount of about 5 to about 20 parts by weight per 100 parts by weight of the wheat flour, and the raw materials of the baked confectionery are mainly composed of those of vegetable origin. Its dough is prepared by the generally employed method as described above, and wheat flour and the soybean protein constituent raw material are preliminarily mixed. Patent Document 4 proposes a process for producing baked confectionery comprising using a soybean protein-containing material, tapioca starch and trehalose in baked confectionery dough. This process also adopts a conventional method, i.e., the flour batter method, and powders of the soybean protein, tapioca starch powder, and trehalose powder are mixed.

Patent Document 1: JP 11-169063 A

Patent Document 2: JP 6-319434 A

Patent Document 3: JP 61-28347 A

Patent Document 4: JP 11-9176 A

### DISCLOSURE OF THE INVENTION

### Problem to be Solved by the Invention

An object of the present invention is to provide a process for producing soybean protein-containing wheat dough which hardly undergoes influence of strong water absorption properties of soybean protein even in dough using soybean protein and has less change in hardness of the dough with time and good workability.

### Means for Solving the Problem

For the above problem, the present inventors have studied processes different from conventional processes without prejudice to conventional processes, and found that, by preliminarily preparing a plastic mixture of soybean protein with a sugar in the form of liquid in the production of soybean protein-containing wheat dough, soybean protein constituent absorbs water in the sugar, and the soybean protein gradually firms up to alleviate strong water absorption properties of the soybean protein. Thus, the present invention has been completed.

That is, the first aspect of the present invention is a process for producing wheat dough which comprises adding soybean protein as a plastic mixture with a sugar in the form of liquid having been preliminarily prepared. The second aspect of the present invention is the process for producing wheat dough according to the first aspect, wherein the amount of the soybean protein as soybean protein constituent in the plastic mixture of the soybean protein and the sugar in the form of liquid is 12 to 38% by weight in terms of anhydrous solid matter. The third aspect of the present invention is the process for producing wheat dough according to the first or second aspect, wherein a water activity value of the sugar in the form of liquid to be used for the plastic mixture is 0.95 or less. The fourth aspect of the present invention is the process for producing wheat dough according to any one of the first to the third aspects, wherein the amount of the soybean protein in the wheat dough as soybean protein constituent is 1 to 13% by weight in terms of anhydrous solid matter. The fifth aspect is a process for producing a wheat product which comprises heating the wheat dough according to any one of the first to fourth aspects.

### Effect of the Invention

It has become possible to provide a process for producing soybean protein-containing wheat dough which hardly undergoes influence of strong water absorption properties of soybean protein even in wheat dough using soybean protein, and has less change in hardness of the dough with time and good workability.

### BEST MODE FOR CARRYING OUT THE INVENTION

In the process for producing soybean protein-containing wheat dough of the present invention, it is necessary to add soybean protein as a plastic mixture with a sugar in the form or liquid to wheat flour. Other operations may be carried out according to a conventional process for producing wheat dough. At this time, fat or oil, and an egg which are generally used as wheat dough raw materials can be appropriately selected and used. By producing dough like this, soybean protein-containing wheat dough, which hardly undergoes influence of strong water absorption properties of soybean protein and has little change in hardness of the dough with time and good workability, can be obtained. Examples of the sugar in the form of liquid to be used in the present invention include commercially available sugars in the form of liquid. In case of a granular or powdery sugar having a low moisture content, a hydrous sugar thereof can be used and, from a viewpoint of storability a sugar having a water activity value (Aw) of 0.95 or less, further 0.90 or less is preferable. Examples of the sugars include monosaccharides such as glucose, fructose, mannose, xylose, etc., oligosaccharides such as sucrose, maltose, lactose, trehalose, maltotriose, etc., and sugar alcohols such as sorbitol, maltitol, mannitol, erythritol, xylitol, etc.

In the present invention, soybean protein is added to wheat flour as a plastic mixture with the sugar in the form of liquid having been preliminary prepared, and the amount of the sugar in the plastic mixture is preferably 60 to 80% by weight, further preferably 65 to 80% by weight. When the sugar in the form of liquid is less than the lower limit, the mixture becomes flake-like, and a uniform kneading operation becomes difficult. On the other hand, when the sugar in the form of liquid exceeds the upper limit, flowability becomes too high, plasticity is reduced, and separation phenomenon occurs in the kneading operation in some cases.

Examples of the soybean protein used in the present invention include soybean protein isolate, soybean protein concentrate, hydrolyzed soybean protein, preparative soymilk powder, soybean powder, defatted soybean powder, soybean yellowish flour, and the like, and the soybean protein can be used alone, or can be used by mixing two or more kinds. The content of soybean protein constituent is expressed in terms of anhydrous solid matter, and is measured by the analysis according to a Kjeldahl method described in page 24 of “New Food Analysis Handbook, 1st edition, published on Nov. 20, 2000, publisher: KENPAKUSHA”.

In the present invention, the soybean protein is added to wheat flour as a plastic mixture with the sugar in the form of liquid sugar having been preliminary prepared, and the amount of the soybean protein as soybean protein constituent in the plastic mixture is preferably 12 to 38% by weight, further preferably 18 to 33% by weight in terms of anhydrous solid matter. When the amount of soybean protein constituent is less than the lower limit, dough becomes soft, and it is difficult to obtain plasticity. When the amount exceeds the upper limit, dough becomes hard, or becomes flake-like, and a uniform kneading operation becomes difficult, thereby causing difficulty in obtaining soybean protein-containing wheat dough.

By preliminarily mixing the soybean protein with the sugar in the form of liquid, the soybean protein absorbs water in the sugar in the form of liquid. Thus, the soybean protein gradually firms up. Although time necessary for firming up varies depending on a particular production process, 30 minutes to about 1 hour is sufficient.

In the soybean protein-containing wheat dough obtained in the above process, the amount of the soybean protein in the wheat dough as soybean protein constituent is preferably 1 to 13% by weight, more preferably 3.5 to 13% by weight in terms of anhydrous solid matter. When the amount of soybean protein constituent is less than the lower limit, it becomes difficult to obtain soybean protein constituent necessary for the desired nutrient value of the present invention. When the amount exceeds the upper limit, flowability of dough becomes worse, which results in deterioration of workability.

In the present invention, the soybean protein is preliminarily prepared into a plastic mixture with the sugar in the form of liquid. Plasticity referred to in the present invention means such a physical property that a mixture has appropriate consistency and smooth texture, and can be uniformly mixed with raw materials which are generally used in wheat dough raw materials such as fats or oils, powdery sugars, eggs, and the like, and plasticity can be expressed as hardness determined by a rheometer. A hardness index at 20° C. is preferably 0.1 cm² to 49 cm²/0.785 cm², further preferably 0.4 cm² to 38 cm²/0.785 cm² as measured by the method described herein.

Examples of wheat flour used in the present invention include soft flour, medium flour, and strong flour. Examples of other raw materials include eggs, and there are a whole egg, an egg yolk, and an egg white, as well as a sugar-added egg, and frozen eggs thereof. These can be used alone, or in combination of two or more thereof.

Examples of the fats or oils used in the present invention include animal or vegetable fats or oils and hydrogenated fats or oils thereof. They can be used alone or in combination of two or more thereof. Or, chemically or physically treated fats or oils thereof can also be used. Examples of such fats or oils include various animal or vegetable origin such as soybean oil, cottonseed oil, corn oil, safflower oil, olive oil, palm oil, rapeseed oil, rice bran oil, sesame oil, kapok oil, coconut oil, palm kernel oil, cacao butter, milk fat, lard, fish oil, whale oil, and the like, and processed fats or oils thereof (having a melting point of about 10 to 40° C.) such as hydrogenated oil, fractionated oil, and interesterified oil thereof. Further, processed fats or oils such as margarine and shortening can also be used. A melting point of fats or oils is preferably 20 to 38° C. from the viewpoint of a flavor and plasticity of dough.

The wheat product of the present invention can be obtained by heating the soybean protein-containing wheat dough obtained by the aforementioned process. A variety of the wheat products can be obtained by various heating methods selected from, for example, baking, steaming, frying, and microwave irradiation. Specifically, as the product obtained by baking the soybean protein-containing wheat dough of the present invention, a fruit cookie having a moist mouthfeel, or a Westernized Japanese confectionery having a soft mouthfeel can be obtained by crusting a heat resistant filling such as jam and bean jam, and baking it by a conventional method,. Alternatively, as the steamed or fried product, moist steamed bean-jam bun, and fried confectionery can be obtained by preparing bread-like dough into which the plastic sugar-soybean protein dough is kneaded as external layer, crusting a sweet filling such as bean jam as a core layer with the external layer, and subjecting it to steaming or frying.

### EXAMPLES

Hereinafter, the present invention will be explained in more detail by way of Examples of the present invention. However, the spirit of the present invention is not limited by the following Examples. In Examples, percents and parts are by weight.

The hardness was measured with a rheometer (Fudo Kogyo Co., Ltd.). The measurement was carried out under the measuring conditions of a sample container: internal diameter 58 mm, height 31 mm; a plunger: diameter 10 mm; a feed rate 5 cm/min, and recording a load on the plunger at 25 mm penetration as 1 volt signal with a printer (RIKADENKI KOGYO, ELECTRONIC RECORDER MODEL FR-31) (chart speed 5 cm/min). The area of a peak obtained was used as an index for expressing the hardness. The measurement was carried out at a product temperature of 20° C. and, in case that the product was particularly soft, the measurement was carried out at a scale of 200 g (measuring range 0 to 200 g) and, in other cases, measurement was carried out at a scale (0 to 2000 g), and the peak area measured at a scale of 200 g was corrected into 1/10 because the area was enlarged and outputted 10-fold the area of a scale (0 to 2000 g).

### Experimental Examples 1 to 3

Plastic mixtures of soybean protein/sugar in the form of liquid of Experimental Examples 1 to 3 were obtained by mixing 80 parts, 70 parts and 60 parts of reduced maltose starch syrup (manufactured by Towa Chemical Industry Co., Ltd., “Amalty Syrup”, solid content of 75% by weight, water activity value Aw of 0.79), and 20 parts, 30 parts and 40 parts of preparative soymilk powder (manufactured by Fuji Oil Co., Ltd., “SoyFit 2000”, a protein content of 63% by weight in terms of a solid content) at room temperature of 20° C. at a medium mixing rate with Kenwood mixer (manufactured by Aikoh) equipped with a mixing wing beater, respectively. They are summarized in Table 1. Further, these plastic mixtures were allowed to stand under room temperature for 0 minute to 1 hour to adapt the sugar to the preparative soymilk powder sufficiently. The results of the hardness indexes of these plastic mixtures are summarized in Table 2.

### Experimental Examples 4 to 8

According to the same manner as that of Experimental Examples 1 to 3, plastic mixtures of soybean protein/sugar in the form of liquid of Experimental Examples 4 to 8 were obtained by using a sorbitol solution (manufactured by Towa Chemical Industry Co., Ltd., “Foodle 70”, D-sorbitol 54%, reduced starch saccharified product 16%, water 30%, water activity value Aw 0.75), reduced maltose starch syrup (manufactured by Towa Chemical Industry Co., Ltd., “Amalty Syrup”, solid content of 75% by weight, water activity value Aw of 0.79), and powdery soybean protein isolate (manufactured by Fuji Oil Co., Ltd., “New Fujipro 1200”, protein content of 93% by weight in terms of solid matter) in the formulation described in Table 1. They are summarized in Table 1. Similarly, the mixtures were allowed to stand at room temperature for 0 minute to 1 hour. The results of the hardness indexes are summarized in Table 2.

### Experimental Examples 9 and 10

According to the same manner as that of Experimental Examples 1 to 3, plastic mixtures of soybean protein/sugar in the form of liquid of Experimental Examples 9 and 10 were obtained by using reduced maltose starch syrup (manufactured by Towa Chemical Industry Co., Ltd., “Amalty Syrup”, solid content of 75% by weight, water activity value Aw of 0.79), water, and powdery soybean protein isolate (manufactured by Fuji Oil Co., Ltd. “New Fujipro 1200”, protein content of 93% by weight in terms of solid matter) were used in the formulation described in Table 1. They are summarized in Table 1. Similarly, they were allowed to stand at room temperature for 0 minute to 1 hour. The results of the hardness indexes are summarized in Table 2.

TABLE 1
Formulation and physical properties of soybean protein/sugar in the form of liquid

| | Experimental | Experimental | Experimental | Experimental | Experimental |
|---|---|---|---|---|---|
| | Example 1 | Example 2 | Example 3 | Example 4 | Example 5 |
| Reduced maltose starch syrup | 80 | 70 | 60 | 59 | 51 |
| Sorbitol solution | — | — | — | 21 | 19 |
| Water | — | — | — | — | — |
| Preparative soymilk powder | 20 | 30 | 40 | — | — |
| Powdery soybean protein isolate | — | — | — | 20 | 30 |
| Water activity value of sugar in | 0.79 | 0.79 | 0.79 | 0.78 | 0.78 |
| the form of liquid AW | | | | | |
| % by weight of soybean protein in | 12.6 | 18.9 | 25.2 | 18.6 | 27.9 |
| plastic mixture | | | | | |
| AW of plastic mixture | 0.71 | — | — | — | — |
| | Experimental | Experimental | Experimental | Experimental | Experimental |
| | Example 6 | Example 7 | Example 8 | Example 9 | Example 10 |
| Reduced maltose starch syrup | 48 | 44 | 37 | 36.3 | 38.8 |
| Sorbitol solution | 17 | 16 | 13 | — | — |
| Water | — | — | — | 36.2 | 38.7 |
| Preparative soymilk powder | — | — | — | — | — |
| Powdery soybean protein isolate | 35 | 40 | 50 | 27.5 | 22.6 |
| Water activity value of sugar in | 0.78 | 0.78 | 0.78 | 0.95 | 0.95 |
| the form of liquid AW | | | | | |
| % by weight of soybean protein in | 32.6 | 37.2 | 46.5 | 22.8 | 20.1 |
| plastic mixture | | | | | |
| AW of plastic mixture | — | 0.75 | — | 0.94 | 0.89 |

TABLE 2
Change of plastic mixture of soybean protein/sugar in the form of liquid with time

| | Experimental | Experimental | Experimental | Experimental | Experimental |
|---|---|---|---|---|---|
| | Example 1 | Example 2 | Example 3 | Example 4 | Example 5 |
| Standing time 0 minute | 0.2 | 2.8 | 18.7 | 0.3 | 5.4 |
| Standing time 30 minutes | 0.2 | 5.6 | 29.9 | 0.4 | 9.2 |
| Standing time 60 minutes | 0.2 | 7.9 | 37.9 | 0.4 | 11.4 |
| State of plastic mixture | low | better | hard, but | viscous | soft, solid |
| | viscosity, | massy, | kneadable | pasty, | kneadable |
| | pasty, | kneadable | | kneadable | |
| | kneadable | | | | |
| | Experimental | Experimental | Experimental | Experimental | Experimental |
| | Example 6 | Example 7 | Example 8 | Example 9 | Example 10 |
| Standing time 0 minute | 7.4 | 21.7 | not measured | 15.5 | 5.4 |
| Standing time 30 minutes | 11.3 | 39.3 | | 24.5 | 7.5 |
| Standing time 60 minutes | 15.5 | 48.7 | | 30.8 | 9.6 |
| State of plastic mixture | slightly | hard, but | flake-like | hard, but | soft, solid, |
| | hard, but | kneadable | and not | kneadable | kneadable |
| | kneadable | | kneadable | | |

### Results of Experimental Examples 1 to 10

Since the plastic mixture of soybean protein/sugar in the form of liquid of Experimental Example 1 whose soybean protein was 12.6% by weight was low viscosity and pasty, it was acceptable with respect to softness. Further, the plastic mixture of Experimental Example 7 whose soybean protein was 37.2% by weight was acceptable with respect to hardness. Furthermore, the water activity value of sugar in the form of liquid was preferably 0.95 or less from the viewpoint of keeping. Moreover, similarly, from the viewpoint of keeping, the water active value of the plastic mixture of soybean protein/sugar in the form of liquid was preferably 0.95 or less, further preferably 0.90 or less. From the viewpoint of the hardness range suitable for easy kneading of the plastic mixture of soybean protein/sugar in the form of liquid into soybean protein-containing wheat dough, the amount of soybean protein in the plastic mixture of soybean protein/sugar in the form of liquid was preferably 12 to 38% by weight, further preferably 18 to 33% by weight.

### Examples 1 to 3

According to the formulation shown in Table 3, 7.7 parts, 18.6 parts or 36.3 parts of the plastic mixture of soybean protein/sugar in the form of liquid obtained in Experimental Example 2 which had been allowed to stand at room temperature for 1 hour, and 19.1 parts, 18.5 parts or 18.2 parts of shortening (manufactured by Fuji Oil Co., Ltd., “Pampas LB”) were mixed, further, 27.4 parts, 18.5 parts or 18.2 parts of white sugar (in order to adjust the amount of the sugar in dough to each other, the amount of white sugar was increased or decreased) was mixed, sodium chloride, an egg and water described in Table 3 (in order to adjust hardness of dough, the amount was increased or decreased) were mixed, and further, 36.4 parts, 35.2 parts or 24.5 parts of soft flour, 1.9 parts, 1.9 parts or 1.8 parts of skim milk powder, and 0.4 part of baking powder were mixed to obtain soybean protein-containing wheat dough. They are summarized in Table 3. Similarly, they were allowed to stand at room temperature for 0 minute to 1 hour. The results of the hardness indexes are summarized in Table 4.

### Comparative Examples 1 and 2

Dough was prepared using the same amounts of the same materials as those in Examples according to a conventional method without preliminarily preparing a plastic mixture of soybean protein/sugar in the form of liquid. According to the formulation shown in Table 3, 18.4 parts or 17.3 parts of shortening, 18.4 parts or 4.8 parts of white sugar, 12.9 parts or 24.3 parts of reduced maltose starch syrup and, further, sodium chloride were mixed, an egg and water were mixed and, finally, 35 parts or 32.8 parts of soft flour, 1.8 parts and 1.7 parts of skim milk powder, 0.4 part of baking powder, and 5.5 parts or 10.4 part of preparative soymilk powder were mixed to prepare dough. They are summarized in Table 3. The results of hardness of the dough are summarized in Table 4.

TABLE 3
Formulation of soybean protein-containing wheat dough

| | | | | Comparative | Comparative |
|---|---|---|---|---|---|
| | Example 1 | Example 2 | Example 3 | Example 1 | Example 2 |
| Plastic mixture obtained in | 7.7 | 18.6 | 36.3 | — | — |
| Experimental Example 2 | | | | | |
| Shortening | 19.1 | 18.5 | 18.2 | 18.4 | 17.3 |
| White sugar | 27.4 | 18.5 | 5 | 18.4 | 4.8 |
| Sodium chloride | 0.2 | 0.2 | 0.2 | 0.2 | 0.2 |
| Egg | 3.8 | 3.7 | 1.8 | 3.7 | 5.2 |
| Water | 3.1 | 3 | 1.8 | 3.7 | 2.9 |
| Soft flour | 36.4 | 35.2 | 34.5 | 35 | 32.8 |
| Skim milk powder | 1.9 | 1.9 | 1.8 | 1.8 | 1.7 |
| Baking powder | 0.4 | 0.4 | 0.4 | 0.4 | 0.4 |
| Preparative soymilk powder | — | — | — | 5.5 | 10.4 |
| Reduced maltose starch syrup | — | — | — | 12.9 | 24.3 |
| wt % of soybean protein in dough | 1.5 | 3.5 | 6.9 | 3.5 | 6.5 |

TABLE 4
Hardness of, and change in hardness with time of soybean protein-containing wheat dough

| | | | | Comparative | Comparative |
|---|---|---|---|---|---|
| | Example 1 | Example 2 | Example 3 | Example 1 | Example 2 |
| Standing time 0 minute | 3.2 | 3.7 | 4.8 | 3.2 | 4.5 |
| Standing time 30 minutes | 3.6 | 4.3 | 5.8 | 4.6 | 6.5 |
| Standing time 60 minutes | 3.9 | 4.4 | 6.4 | 5.4 | 7.7 |

### Examples 4 and 5

According the formulation shown in Table 5, 7.9 parts or 33.2 parts of the plastic mixture of soybean protein/sugar in the form of liquid obtained in Experimental Example 1 or Experimental Example 7 which had been allowed to stand at room temperature for 1 hour, and 19.7 parts or 16.6 parts of shortening (manufactured by Fuji Oil Co., Ltd., “Pampas LB”) were mixed, further, 27 parts or 8.3 parts of white sugar (in order to adjust the amount of the sugar in dough, the amount of white sugar was increased and decreased) was mixed, sodium chloride, an egg and water described in Table 5 (in order to adjust dough hardness, the amount was increased and decreased) were mixed and, further, 37.2 parts or 31.4 parts of soft flour, 2 parts or 1.7 parts of skim milk powder, and 0.4 part or 0.3 part of baking powder were mixed to obtain soybean protein-containing wheat dough. They are summarized in Table 5. Similarly, they were allowed to stand at room temperature for 0 minute to 1 hour. The results of hardness indexes are summarized in Table 6.

### Comparative Examples 3 and 4

Dough was prepared using the same amounts of the same materials as those of Examples according to a conventional method without preliminarily preparing a plastic mixture of soybean protein/sugar in the form of liquid. According to the formulation shown in Table 5, 19.8 parts or 16.9 parts of shortening, 27.3 parts or 8.4 parts of white sugar, 6.3 parts of reduced maltose starch syrup, or 14.8 parts of reduced maltose starch syrup and 5.4 parts of a sorbitol solution and, further, sodium chloride were mixed, an egg and water were mixed and, finally, 37.6 parts or 32 parts of soft flour, 2 parts or 1.7 parts of skim milk powder, 0.4 part or 0.3 part of baking powder, and 1.6 parts of preparative soymilk powder or 13.5 parts of powdery separated soybean protein were mixed to prepare dough. They are summarized in Table 5. The results of hardness of the dough are summarized in Table 6.

TABLE 5
Formulation of soybean protein-containing wheat dough

| | | | Comparative | Comparative |
|---|---|---|---|---|
| | Example 4 | Example 5 | Example 3 | Example 4 |
| Plastic mixture | 7.9 | — | — | — |
| obtained in | | | | |
| Experimental | | | | |
| Example 1 | | | | |
| Plastic mixture | — | 33.2 | — | — |
| obtained in | | | | |
| Experimental | | | | |
| Example 7 | | | | |
| Shortening | 19.7 | 16.6 | 19.8 | 16.9 |
| White sugar | 27 | 8.3 | 27.3 | 8.4 |
| Sodium chloride | 0.2 | 0.2 | 0.2 | 0.2 |
| Egg | 2.8 | 3.3 | 2.4 | 3.4 |
| Water | 2.8 | 5 | 2.4 | 3.4 |
| Soft flour | 37.2 | 31.4 | 37.6 | 32 |
| Skim milk powder | 2 | 1.7 | 2 | 1.7 |
| Baking powder | 0.4 | 0.3 | 0.4 | 0.3 |
| Preparative | — | — | 1.6 | — |
| soymilk powder | | | | |
| Powdery separated | — | — | — | 13.5 |
| soybean protein | | | | |
| Reduced maltose | — | — | 6.3 | 14.8 |
| starch syrup | | | | |
| Sorbitol solution | — | — | — | 5.4 |
| wt % of soybean | 1 | 12.3 | 1 | 12.6 |
| protein in dough | | | | |

TABLE 6
Hardness of, and change in hardness with time of soybean
protein-containing wheat dough

| | | | Comparative | Comparative |
|---|---|---|---|---|
| | Example 4 | Example 5 | Example 3 | Example 4 |
| Standing time 0 | 3.7 | 4.8 | 3.6 | 4.7 |
| minute | | | | |
| Standing time 30 | 4.1 | 6.3 | 4.5 | 6.7 |
| minutes | | | | |
| Standing time 60 | 4.5 | 6.9 | 5.1 | 7.8 |
| minutes | | | | |

### Results of Examples 1 to 5

The measurement data of hardness of soybean protein-containing wheat dough show that, in Examples 1 to 5 wherein the plastic mixtures of soybean protein/sugar in the form of liquid are preliminarily prepared and are used in soybean protein-containing wheat dough, the change in the dough hardness of the dough obtained is mild and the change in the dough hardness of the dough obtained is suppressed, as compared with Comparative Examples 1 to 4, wherein no plastic mixture is preliminarily prepared.

The data show that, as the index value cm² of dough hardness immediately after mixing is greater, the resulting dough is hard and, conversely, as the value is smaller, the dough is soft. There was a tendency that dough became harder when storage time at room temperature became longer, as compared with immediately after mixing. In particular, in a conventional process shown in Comparative Examples, the change in the dough hardness was great. To the contrary, in the process of Examples wherein the plastic mixture of soybean protein/sugar in the form of liquid was preliminarily prepared, the change in dough hardness was mild. Then, in the formulation wherein the dough was prepared according to the process of the present invention with using even a larger amount of soybean protein, it was possible to suppress the change in dough hardness, and to improve workability.

While soybean protein absorbs water, it firms up with time and becomes hard, when a large amount of sodium chloride is present in this system, firming up becomes mild. The present inventors have assumed that sugar has the same firming up suppressing function, and have carried out various experiments. As a result, the present inventors have found out that, although a mixed product of soybean protein and water crumbles with less smoothness, a mixture of soybean protein and sugar in the form of liquid having a certain water activity value absorbs water in a sugar solution and gradually firms up while maintaining a smooth state suitable for kneading, and firming up approaches the equilibrium state within about 1 to 2 hours.

### Example 6

Using 15 g of the soybean protein-containing wheat dough obtained in Example 2 in an external layer of dough, and 10 g of a fruit filling (Umehara Co., Ltd., “Peach Cut 7 Milli, White Peach”) in a core material, the core material was encrusted with the external dough to obtain a steamed bean-jam bun-like bilayer structure, and this was baked in an electric oven at 170° C. for 15 minutes to obtain a fruit cookie.

### Comparative Example 5

Using 15 g of the dough obtained in Comparative Example 1 in an external layer of dough, and 10 g of a fruit filling (Umehara Co., Ltd., “Peach Cut 7 Milli, White Peach”) in a core material, the core material was encrusted with the external dough to obtain a steamed bean-jam bun-like bilayer structure, and this was baked in an electric oven at 170° C. for 15 minutes to obtain a fruit cookie.

### Results of Example 6 and Comparative Example 5

In the dough of Comparative Example 5, the change in hardness of dough after 30 minutes and 60 minutes was great as compared with the hardness immediately after completion of mixing, and a crack was generated in dough by manually encrusting operation. In the dough of Example 6, the change in hardness was small, and the smooth and better plastic state was maintained for a long time. In addition, the cookie of Example 6 had a strong wet feeling, and a moist mouthfeel, and was a differentiated fruit cookie.

### INDUSTRIAL APPLICABILITY

The present invention relates to a process for producing soybean protein-containing wheat dough which comprises adding soybean protein as a plastic mixture with sugar in the form of liquid having preliminarily prepared, and a process for producing a wheat product by heating the dough, and relates to a process for producing cookies, baked confectionery, bread and steamed products excellent in a nutritive value and workability which uses the dough.

1. A process for producing wheat dough which comprises adding soybean protein as a plastic mixture with a sugar in the form of liquid having been preliminarily prepared.

2. The process for producing wheat dough according to claim 1, wherein the amount of the soybean protein as soybean protein constituent in the plastic mixture of the soybean protein and the sugar in the form of liquid is 12 to 38% by weight in terms of anhydrous solid matter.

3. The process for producing wheat dough according to claim 1, wherein a water activity value of the sugar in the form of liquid to be used for the plastic mixture is 0.95 or less.

4. The process for producing wheat dough according to claim 1, wherein the amount of the soybean protein in the wheat dough as soybean protein constituent is 1 to 13% by weight in terms of anhydrous solid matter.

5. A process for producing a wheat product which comprises heating the wheat dough according to claim 1.
